(19) United States
(12) Patent Application Publication
(10) Pub. No.: US 2009/0117280 A1
(43) Pub. Date: May 7, 2009

(54) COATING SYSTEM AND COATING METHOD

(75) Inventor: Daisuke Nakazono, Tochigi-ken (JP)

Correspondence Address: ARENT FOX LLP, 1050 CONNECTICUT AVENUE, N.W., SUITE 400, WASHINGTON, DC, 20036, US

(73) Assignee: HONDA MOTOR CO., LTD., Tokyo (JP)

(21) Appl. No.: 12/295,193

(22) PCT Filed: Apr. 11, 2007
(86) PCT No.: PCT/JP2007/058388

§ 371 Date: Sep. 29, 2008

(30) Foreign Application Priority Data
Apr. 12, 2006 (JP) 2006-109664
Apr. 12, 2006 (JP) 2006-109698

(51) Int. Cl. B05D 7/00; B05C 11/00

(52) U.S. Cl. 427/258; 118/506

(57) ABSTRACT

A coating system includes an intermediate coat applying process, an overcoat applying process, and a clear coat applying process, which are disposed successively along a coating flow direction. The intermediate coat applying process includes first through fourth intermediate coat applying stations through, which are disposed in parallel to each other across a coating line. The overcoat applying process includes first through sixth overcoat applying stations through, which are disposed in parallel to each other across the coating line. At least each of the first through third overcoat applying stations through has a plurality of coating robots for applying coats having different colors.

### TECHNICAL FIELD

The present invention relates to a coating system and a coating method, which have at least an intermediate coat applying process and an overcoat applying process, for coating portions of an outer panel and an inner panel of a workpiece to be coated.

### BACKGROUND ART

Coating production lines for coating workpieces, e.g., vehicle bodies, have a rust-prevention undercoat applying process (electrodepositing process), an intermediate coat applying process, an overcoat applying process, and a clear coat applying process for coating white bodies, and also have a baking process between any successive two of the foregoing coating processes.

There has been proposed a coating apparatus for use in such a coating line for purposes of reducing the number of coating robots used and for saving kinetic energy supplied to each of the coating booths, i.e., coating stations (see Japanese Patent Application No. 2001-129449).

As shown in FIG. 16 of the accompanying drawings, two proposed coating apparatuses are applied to an overcoat applying process between an intermediate coat applying process and a baking process. Each of the coating apparatuses has a unitized coating booth 1 for applying a base coat and a unitized coating booth 2 for applying a clear coat. The coating booths 1, 2 are arranged in series along a feed path 3. The coating booth 1 includes a plurality of spray coating robots 4, and the coating booth 2 includes a plurality of spray coating robots 5.

One of the coating apparatuses, which is shown as an upper coating apparatus in FIG. 16, is referred to as a first module A, whereas the other coating apparatus, which is shown as a lower coating apparatus in FIG. 16, is referred to as a second module B. Each of the first and second modules A and B is set so as to have a minimum production capacity. In order to increase the production volume of the entire coating line, the first and second modules A and B are operated simultaneously. In order to reduce the production volume of the entire coating line, the second module B, for example, may be shut off.

On the coating line shown in FIG. 16, the first module A and the second module B, which operate under the same coating conditions, are simply positioned parallel to each other in order to meet certain production requirements. In reality, vehicle bodies are coated variously in many colors, and may be coated twice with an overcoat paint, or twice with a clear coat paint. To satisfy these various coating requirements, many coating lines need to be provided, resulting in a considerably large and complex coating facility. Conventional coating apparatuses thus fail to meet demands in recent years for a wide variety of vehicle coating colors and trends toward the production of vehicles in many types and small quantities.

### DISCLOSURE OF INVENTION

It is an object of the present invention to provide a coating system and a coating method, which are capable of realizing a compact coating facility, lending themselves to the production of vehicles in many types and small quantities, while also performing an efficient coating process.

According to the present invention, a coating system includes at least an intermediate coat applying process and an overcoat applying process, for coating portions of an outer panel and an inner panel of a workpiece to be coated. Each of the intermediate coat applying process and the overcoat applying process includes at least two coating stations, for coating the workpiece under different conditions, wherein the coating stations are disposed in parallel to each other across a coating line.

The intermediate coat applying process and the overcoat applying process may be disposed in parallel to each other across the coating line. The intermediate coat applying process may include at least two coating stations, which are disposed in parallel to each other, for applying coatings having different colors, for example. The overcoat applying process may include at least two coating stations, which are disposed in parallel to each other, for applying coatings having different colors, for example.

According to the present invention, there is also provided a method of coating portions of an outer panel and an inner panel of a workpiece, comprising the steps of providing at least an intermediate coat applying process and an overcoat applying process for coating the workpiece, wherein each of the intermediate coat applying process and the overcoat applying process include at least two coating stations, which are disposed in parallel to each other, for coating the workpiece under different conditions, selecting one of the coating stations, which corresponds to given coating conditions, and coating the workpiece in the selected coating station.

The intermediate coat applying process and the overcoat applying process may be disposed in parallel to each other across a coating line, wherein the intermediate coat applying process includes at least two coating stations, and the overcoat applying process includes at least two coating stations. One of the coating stations of the intermediate coat applying process is selected, and an intermediate coat is applied to the workpiece in the selected coating station of the intermediate coat applying process. The workpiece is returned along a return line to the overcoat applying process. Thereafter, one of the coating stations of the overcoat applying process is selected, and an overcoat is applied to the workpiece in the selected coating station of the overcoat applying process.

According to the present invention, each of the intermediate coat applying process and the overcoat applying process has at least two coating stations, which are disposed in parallel to each other, for coating the workpiece under different conditions. When coating conditions are changed, e.g., when coating colors are changed, only the coating station having the desired coating color may be selected. Therefore, the coating system makes it possible to change setups quickly and easily, for changing coating conditions, e.g., coating colors, or in response to different workpiece types. The coating system thus lends itself to the production of vehicles in many types and small quantities, and enables an efficient coating process to be performed.

Since the coating process is performed quickly, even if a coating robot in each coating station also is used as a door opening and closing robot, the entire coating process is prevented from being delayed. The number of robots used by the coating system may be reduced, thereby making the entire coating facility compact.

According to the present invention, moreover, the intermediate coat applying process and the overcoat applying process, each having at least two coating stations, may be disposed in parallel to each other across the coating line. Consequently, when coating conditions are changed, e.g., when coating colors are changed, only the coating station having the desired coating color may be selected. Therefore, the coating system makes it possible to change setups quickly and easily, for changing coating conditions, e.g., coating colors, or in response to different workpiece types. The coating system thus lends itself to the production of vehicles in many types and small quantities, and enables an efficient coating process to be performed.

Furthermore, since the intermediate coat applying process and the overcoat applying process are disposed in parallel to each other, when coating specifications are changed, only the number of coating stations of each of the intermediate coat applying process and the overcoat applying process needs to be changed.

For example, when the number of overcoating cycles is increased, only the number of coating stations of the intermediate coat applying process needs to be reduced while the number of coating stations of the overcoat applying process needs to be increased. The coating system is thus versatile, in that it is capable of easily and quickly adapting itself to various different coating specifications, enabling the coating process to be performed efficiently and reliably.

The above and other objects, features, and advantages of the present invention will become more apparent from the following descriptions when taken in conjunction with the accompanying drawings, in which preferred embodiments of the present invention are shown by way of illustrative example.

### BRIEF DESCRIPTION OF DRAWINGS

FIG. 1 is a schematic plan view of a coating system according to a first embodiment of the present invention;

FIG. 2 is a fragmentary perspective view of a standard-type coating pattern made up of coating layers;

FIG. 3 is a flowchart of a processing sequence for applying the standard-type coating pattern made up of coating layers;

FIG. 4 is a fragmentary perspective view of a first coating pattern made up of coating layers;

FIG. 5 is a flowchart of a processing sequence for applying the first coating pattern made up of coating layers;

FIG. 6 is a fragmentary perspective view of a second coating pattern made up of coating layers;

FIG. 7 is a flowchart of a processing sequence for applying the second coating pattern made up of coating layers;

FIG. 8 is a schematic plan view of a conventional overcoat applying process;

FIG. 9 is a timing chart of the conventional overcoat applying process;

FIG. 10 is a timing chart of an overcoat applying process according to the first embodiment of the present invention;

FIG. 11 is a schematic plan view of a coating system according to a second embodiment of the present invention;

FIG. 12 is a schematic plan view of the coating system shown in FIG. 11, which is configured to apply the first coating pattern made up of coating layers;

FIG. 13 is a schematic plan view of the coating system shown in FIG. 11, which is configured to apply the second coating pattern made up of coating layers;

FIG. 14 is a schematic plan view of a coating system according to a third embodiment of the present invention;

FIG. 15 is a flowchart of a processing sequence of the coating system shown in FIG. 14; and

FIG. 16 is a schematic plan view of a conventional coating apparatus for carrying out an overcoat applying process.

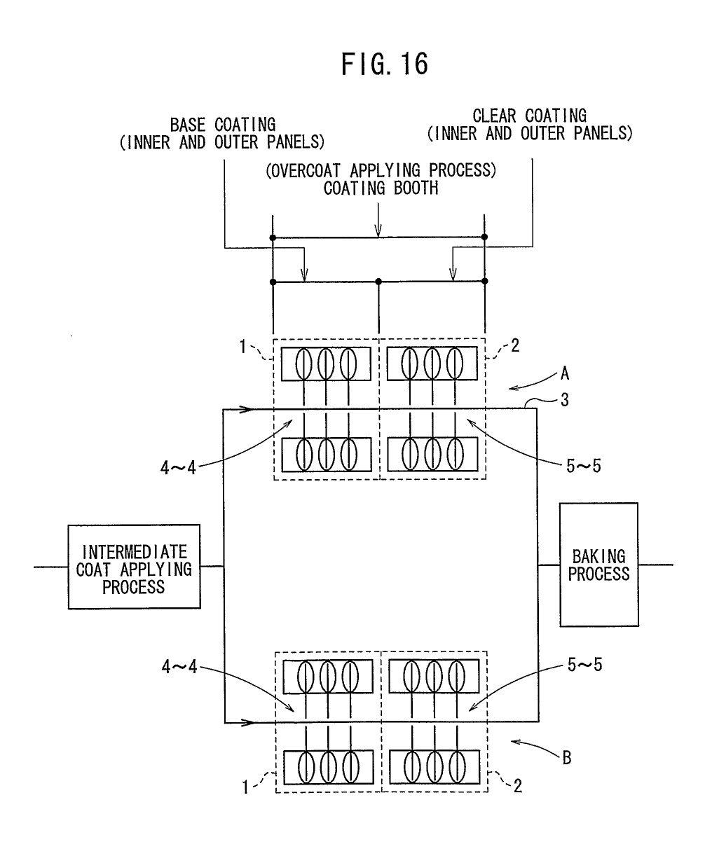

### BEST MODE FOR CARRYING OUT THE INVENTION

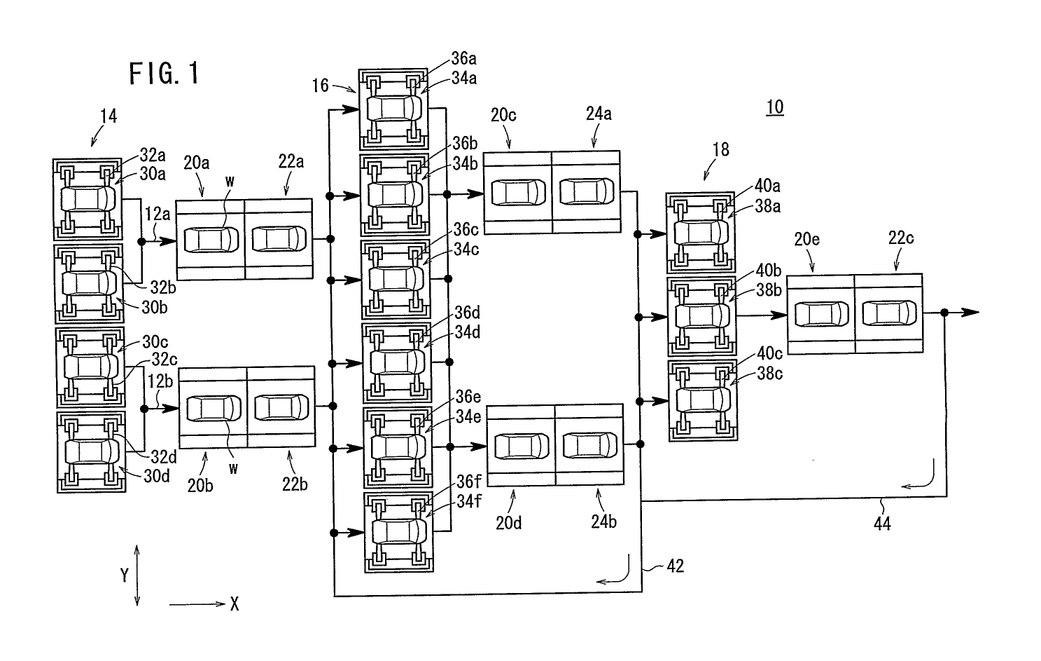

FIG. 1 shows a schematic plan view of a coating system 10 according to a first embodiment of the present invention.

As shown in FIG. 1, the coating system 10 includes a first coating line 12a and a second coating line 12b, which extend in parallel to each other in a coating flow direction, i.e., in the direction indicated by the arrow X. The first coating line 12a and the second coating line 12b are made up of an intermediate coat applying process 14, an overcoat applying process 16, and a clear coat applying process 18, which are successively arranged downstream along the coating flow direction.

The first coating line 12a includes a first setting unit 20a and a first drying furnace (heating unit) 22a disposed between the intermediate coat applying process 14 and the overcoat applying process 16. Similarly, the second coating line 12b includes a second setting unit 20b and a second drying furnace 22b disposed between the intermediate coat applying process 14 and the overcoat applying process 16.

The first coating line 12a includes a third setting unit 20c and a first preheating unit (heating unit) 24a disposed between the overcoat applying process 16 and the clear coat applying process 18. Similarly, the second coating line 12b includes a fourth setting unit 20d and a second preheating unit 24b disposed between the overcoat applying process 16 and the clear coat applying process 18.

The first coating line 12a and the second coating line 12b include a common fifth setting unit 20e and a third drying furnace 22c, disposed downstream of the clear coat applying process 18.

The intermediate coat applying process 14 includes a first intermediate coat applying station 30a, a second intermediate coat applying station 30b, a third intermediate coat applying station 30c, and a fourth intermediate coat applying station 30d, which are disposed in parallel to each other across the first coating line 12a and the second coating line 12b, in the direction indicated by the arrow Y, which is perpendicular to the direction indicated by the arrow X.

The first through fourth intermediate coat applying stations 30a through 30d include respective sets of coating robots 32a, 32b, 32c, 32d. The coating robots 32a through 32d apply an intermediate coat to portions of outer and inner panels of a vehicle body W, which makes up the workpiece to be coated, and partially function at least as door opening and closing robots.

The first intermediate coat applying station 30a and the second intermediate coat applying station 30b serve as respective coating stations operable to apply coats under different coating conditions. For example, the first intermediate coat applying station 30a and the second intermediate coat applying station 30b are operable to apply coatings having different colors, to vehicle bodies W that are fed along the first coating line 12a.

The third intermediate coat applying station 30c and the fourth intermediate coat applying station 30d serve as respective coating stations, operable for selectively applying coats under different coating conditions to vehicle bodies W that are fed along the second coating line 12b.

The first setting unit 20a and the second setting unit 20b serve as stations for retouching, evaporating a solvent, and for settling intermediate coats that have been applied to vehicle bodies W. The first drying furnace 22a and the second drying furnace 22b serve as stations for drying the applied intermediate coats.

The overcoat applying process 16 includes a first overcoat applying station 34a, a second overcoat applying station 34b, a third overcoat applying station 34c, a fourth overcoat applying station 34d, a fifth overcoat applying station 34e, and a sixth overcoat applying station 34f, which are disposed in parallel to each other across the first coating line 12a and the second coating line 12b, in the direction indicated by the arrow Y. The first through sixth overcoat applying stations 34a through 34f include respective sets of coating robots 36a, 36b, 36c, 36d, 36e, 36f.

The first through third overcoat applying stations 34a through 34c are operable for selectively applying coatings under different coating conditions, e.g., coatings having different colors, to the vehicle bodies W that are fed along the first coating line 12a. The fourth through sixth overcoat applying stations 34d through 34f are operable for selectively applying coatings having different colors to the vehicle bodies W that are fed along the second coating line 12b.

If the first overcoat applying station 34a and the second overcoat applying station 34b are set to apply coatings of the same color, and the fourth overcoat applying station 34d and the fifth overcoat applying station 34e are set to apply coatings of the same color, then two different overcoats can selectively be applied to the vehicle bodies W.

The third setting unit 20c and the fourth setting unit 20d are identical in operation to the first setting unit 20a and the second setting unit 20b. The first preheating unit 24a and the second preheating unit 24b serve to preheat the vehicle bodies W, to which overcoats have been applied.

Specifically, the first preheating unit 24a and the second preheating unit 24b serve as stations for tentatively drying overcoats on the overcoated vehicle bodies W, in order to bring a solid coat component of the overcoats into an appropriate range. Each of the first preheating unit 24a and the second preheating unit 24b has an infrared irradiator and/or a hot air supply unit, for example.

The clear coat applying process 18 has a first clear coat applying station 38a, a second clear coat applying station 38b, and a third clear coat applying station 38c. The first through third clear coat applying stations 38a through 38c have respective sets of coating robots 40a, 40b, 40c.

The first clear coat applying station 38a and the third clear coat applying station 38c are operable to form a first clear coat layer, to be described later, on vehicle bodies W that are fed along the first coating line 12a and the second coating line 12b. The second clear coat applying station 38b is operable to form a second clear coat layer (overcoat clear layer) over the first clear layer on the vehicle bodies W on the first coating line 12a and the second coating line 12b.

The first coating line 12a and the second coating line 12b include a first return line 42 for returning vehicle bodies W from positions immediately downstream of the first preheating unit 24a and the second preheating unit 24b, to positions immediately upstream of the overcoat applying process 16, and a second return line 44 for returning vehicle bodies W from a position immediately downstream of the third drying furnace 22c to positions immediately upstream of the clear coat applying process 18.

The first through fourth intermediate coat applying stations 30a through 30d, the first through sixth overcoat applying stations 34a through 34f, and the first through third clear coat applying stations 38a through 38c respectively provide individual air-conditioned booths.

Operation of the coating system 10 shall be described below with regard to a coating method according to the first embodiment of the present invention.

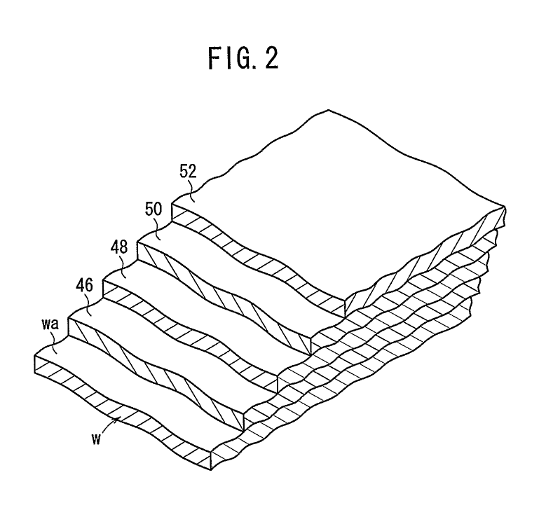

First, application of a standard-type coating pattern of coat layers to a surface Wa of a vehicle body W as shown in FIG. 2 shall be described below. The standard-type coating pattern is made up of an electrodeposited coating layer 46, an intermediate coating layer 48, a base coat layer (overcoat layer) 50, and a clear coat layer 52, which are successively deposited on the vehicle body surface Wa.

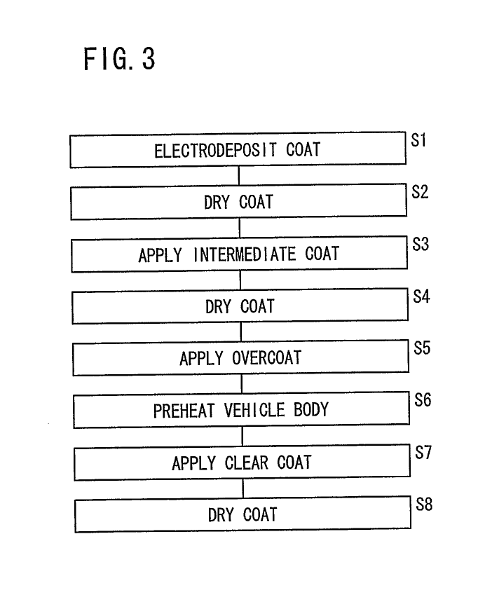

A process for applying the standard-type coating pattern of coating layers shall be described in detail below with reference to the flowchart shown in FIG. 3. In an undercoat applying process (not shown), a water-soluble coating is electrodeposited on the vehicle body surface Wa, forming the electrodeposited coating layer 46 on the vehicle body surface Wa in step S1.

After the electrodeposited coating layer 46 has been dried in a drying furnace (not shown), the vehicle body W is fed along the first coating line 12a to the intermediate coat applying process 14. The second coating line 12b performs the same coating operation as the first coating line 12a. Therefore, only the coating operation performed on the first coating line 12a shall be described below.

In the intermediate coat applying process 14, the vehicle W is supplied to the first intermediate coat applying station 30a, for example, depending on the desired coat color. In the first intermediate coat applying station 30a, an outer panel of the vehicle body W is coated by the coating robots 32a, whereby the doors of the vehicle body W are opened by either one of the coating robots 32a, and a portion of an inner panel of the vehicle body W is coated by the coating robots 32a, thus forming the intermediate coating layer 48 over the electrodeposited coating layer 46 in step S3.

After the intermediate coating layer 48 has been applied to the vehicle body W in the intermediate coat applying process 14, the vehicle body W is fed to the first setting unit 20a, which retouches, evaporates a solvent from, and settles the intermediate coating layer 48. Thereafter, the vehicle body W is introduced into the first drying furnace 22a. The coating layers on the vehicle body W are dried in the first drying furnace 22a in step S4. Then, the vehicle body W is fed to the overcoat applying process 16.

In the overcoat applying process 16, the first through third overcoat applying stations 34a through 34c have different coating colors set therein for application to different vehicle bodies W. The vehicle body W is fed from the first drying furnace 22a to the first overcoat applying station 34a, for example. The coating robot 36a of the first overcoat applying station 34a applies an overcoat to portions of the outer and inner panels of the vehicle body W, thereby forming the base coat layer 50 over the intermediate coating layer 48 in step S5.

After the base coat layer 50 has been applied to the vehicle body W, the vehicle body W is delivered from the first overcoat applying station 34a to the third setting unit 20c. The third setting unit 20c retouches, evaporates a solvent from, and settles the base coat layer 50. Thereafter, the vehicle body W is fed to the first preheating unit 24a. After the vehicle body W has been preheated to a predetermined temperature by the first preheating unit 24a in step S6, the vehicle body W is fed to the first clear coat applying station 38a, for example, of the clear coat applying process 18. In the first clear coat applying station 38a, the coating robots 40a apply a clear coat so as to form the clear coat layer 52 over the base coat layer 50 in step S7.

After the clear coat layer 52 has been formed on the vehicle body W, the vehicle body W is sent to the fifth setting unit 20e, and then dried by the third drying furnace 22c in step S8. The vehicle body W is thereafter delivered to a subsequent process, not shown.

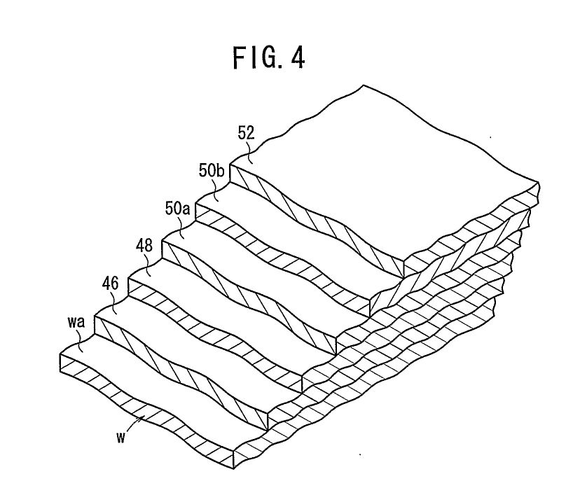

Application of a first coating pattern made up of coating layers to a surface Wa of a vehicle body W as shown in FIG. 4 shall be described below. The first coating pattern is made up of an electrodeposited coating layer 46, an intermediate coating layer 48, a first base coat layer 50a, a second base coat layer 50b, and a clear coat layer 52, which are successively deposited on the vehicle body surface Wa.

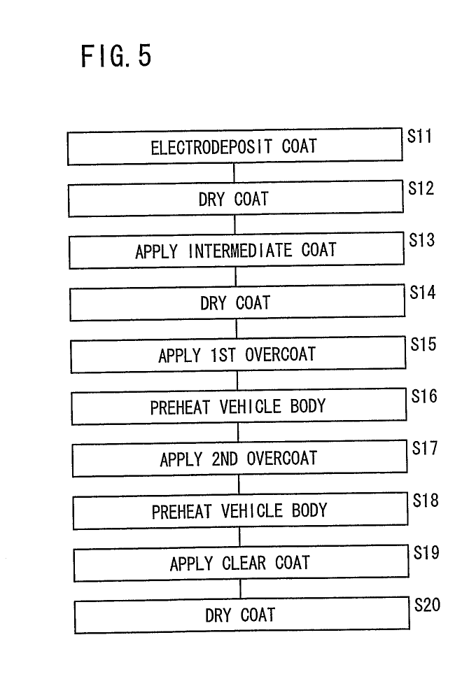

A process for applying the first coating pattern made up of the coating layers shall be described in detail below with reference to the flowchart shown in FIG. 5. Steps S11 through S14 of the process shown in FIG. 5 are carried out in the same manner as steps S1 through S4 shown in FIG. 3. Then, the vehicle body W is fed from the first drying furnace 22a, to the first overcoat applying station 34a, for example, of the overcoat applying process 16. In the first overcoat applying station 34a, the coating robot 36a applies an overcoat so as to form the first base coat layer 50a on the vehicle body W in step S15.

After the first base coat layer 50a has been formed on the vehicle body W, the vehicle body W is processed by the third setting unit 20c, and preheated by the first preheating unit 24a in step S16. Then, the vehicle body W is returned along the first return line 42 to a position immediately upstream of the overcoat applying process 16. The vehicle body W is then fed to the second overcoat applying station 34b, for example, wherein the coating robots 36b form the second base coat layer 50b over the first base coat layer 50a in step S17.

After the second base coat layer 50b has been formed on the vehicle body W, the vehicle body W is processed by the third setting unit 20c, and preheated by the first preheating unit 24a in step S18. Then, the vehicle body W is fed to the first clear coat applying station 38a, for example, of the clear coat applying process 18, which forms the clear coat layer 52 over the second base coat layer 50b in step S19. After the clear coat layer 52 has been formed on the vehicle body W, the vehicle body W is processed by the fifth setting unit 20e, and dried by the third drying furnace 22c in step S20. The vehicle body W is thereafter delivered to a subsequent process, not shown.

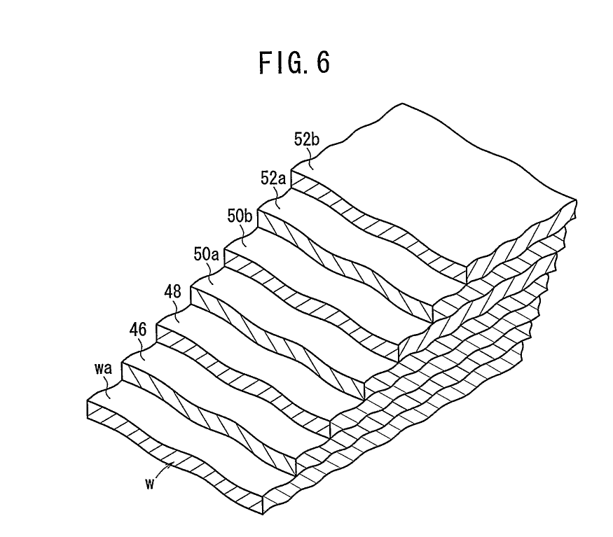

Application of a second coating pattern made up of coating layers to a surface Wa of a vehicle body W as shown in FIG. 6 shall be described below. The second coating pattern is made up of an electrodeposited coating layer 46, an intermediate coating layer 48, a first base coat layer 50a, a second base coat layer 50b, a first clear coat layer 52a, and a second clear coat layer 52b, which are successively deposited on the vehicle body surface Wa.

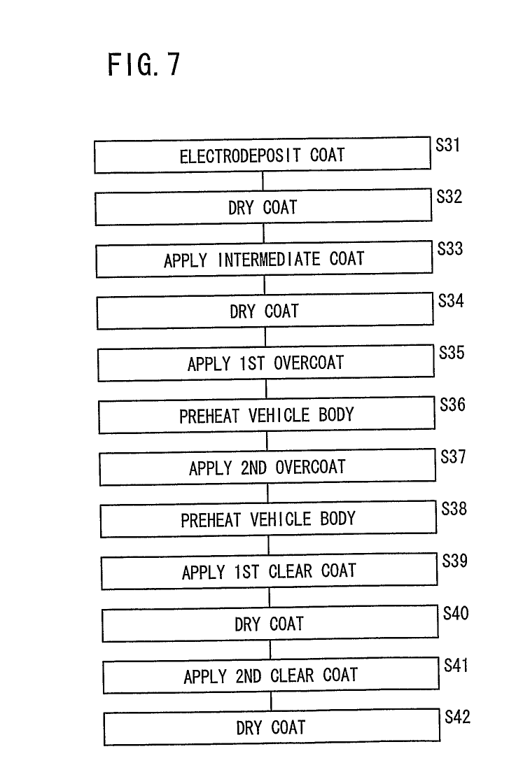

A process for applying the second coating pattern made up of coating layers shall be described in detail below with reference to a flowchart shown in FIG. 7. Steps S31 through S38 of the process shown in FIG. 7 are carried out in the same manner as steps S11 through S18 shown in FIG. 5.

Then, after the second base coat layer 50b has been formed on the vehicle body W, the vehicle body W is fed from the first preheating unit 24a to the first clear coat applying station 38a, which forms the first clear coat layer 52a over the second base coat layer 50b in step S39. The vehicle body W, having been coated with the first clear coat layer 52a, is then processed by the fifth setting unit 20e, and dried by the third drying furnace 22c in step S40. The vehicle body W is then returned along the second return line 44 to a position immediately upstream of the clear coat applying process 18.

The vehicle body W is fed to the second clear coat applying station 38b, for example, in which the coating robots 40b form the second clear coat layer 52b over the first clear coat layer 52a in step S41. The vehicle body W, having been coated with the second clear coat layer 52b, is then processed by the fifth setting unit 20e, and dried by the third drying furnace 22c in step S42. The vehicle body W is thereafter delivered to a subsequent process, not shown.

According to the first embodiment, the intermediate coat applying process 14 includes the first intermediate coat applying station 30a and the second intermediate coat applying station 30b, which have different coating conditions set therein, and which are disposed in parallel to each other across the first coating line 12a. The overcoat applying process 16 includes the first through third overcoat applying stations 34a through 34c, which have different coating conditions set therein, and which are disposed in parallel to each other across the first coating line 12a. The clear coat applying process 18 includes the first clear coat applying station 38a, which is associated with the first coating line 12a, and the second clear coat applying station 38b, which is associated with both the first coating line 12a and the second coating line 12b, wherein the first and second clear coat applying stations 38a, 38b are disposed in parallel to each other. The coating system 10, with the coating stations thus configured, makes it possible to change setups quickly and easily, for thereby changing coating conditions, e.g., coating colors, or different vehicle body types.

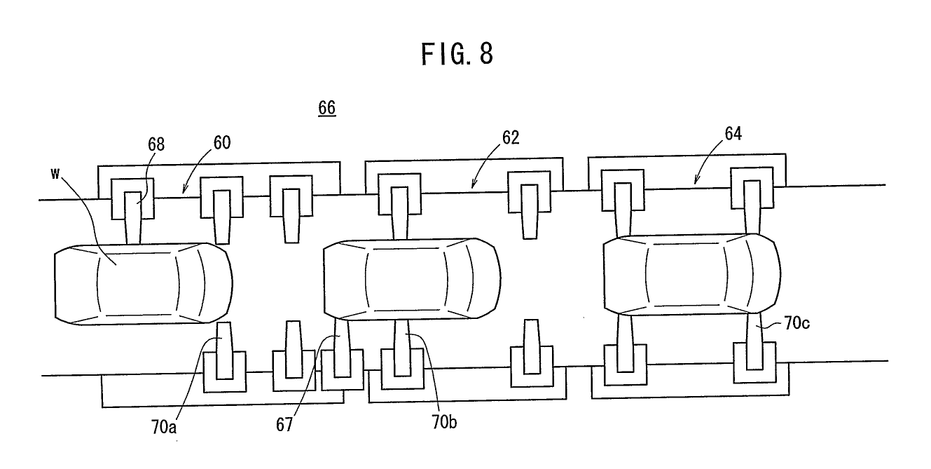

Specifically, a process of applying an overcoat to a vehicle body W in the first through third overcoat applying stations 34a through 34c, as well as a process of applying an overcoat to a vehicle body W in a conventional overcoat applying process 66 (see FIG. 8), in which an inner panel coating station 60, a first outer panel coating station 62, and a second outer panel coating station 64 are disposed in series with each other, shall be described below.

The conventional overcoat applying process 66 includes an opener 67 for keeping the engine hood of the vehicle body W open, and also includes a door opening and closing robot 68. The inner panel coating station 60, the first outer panel coating station 62, and the second outer panel coating station 64 have respective sets of coating robots 70a, 70b, 70c therein.

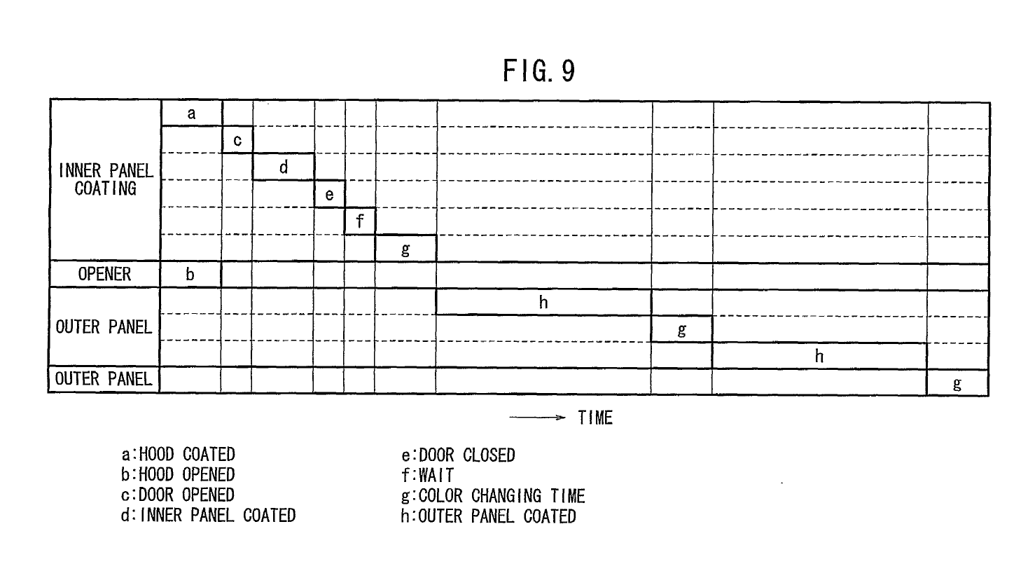

In the conventional overcoat applying process 66, as shown in FIG. 9, while the engine hood of the vehicle body W is held open by the opener 67, an inner panel of the engine hood is coated. Then, while a door is opened by the door opening and closing robot 68, an inner panel of the vehicle body W is coated by coating robots 70a in the inner panel coating station 60.

After the door is closed, and before an outer panel of the vehicle body W starts being coated by the first outer panel coating station 62, the coating process is interrupted for a predetermined color changing time. The color changing time essentially is established as a common setting both for changing coating colors and for not changing coating colors. When necessary, setups including cup cleaning may also be changed during the color changing time.

After the color changing time has elapsed, an outer panel of the vehicle body W is coated by coating robots 70b of the first outer panel coating station 62. Then, the coating process is interrupted for the color changing time. Thereafter, the outer panel of the vehicle body W is coated by coating robots 70c of the second outer panel coating station 64.

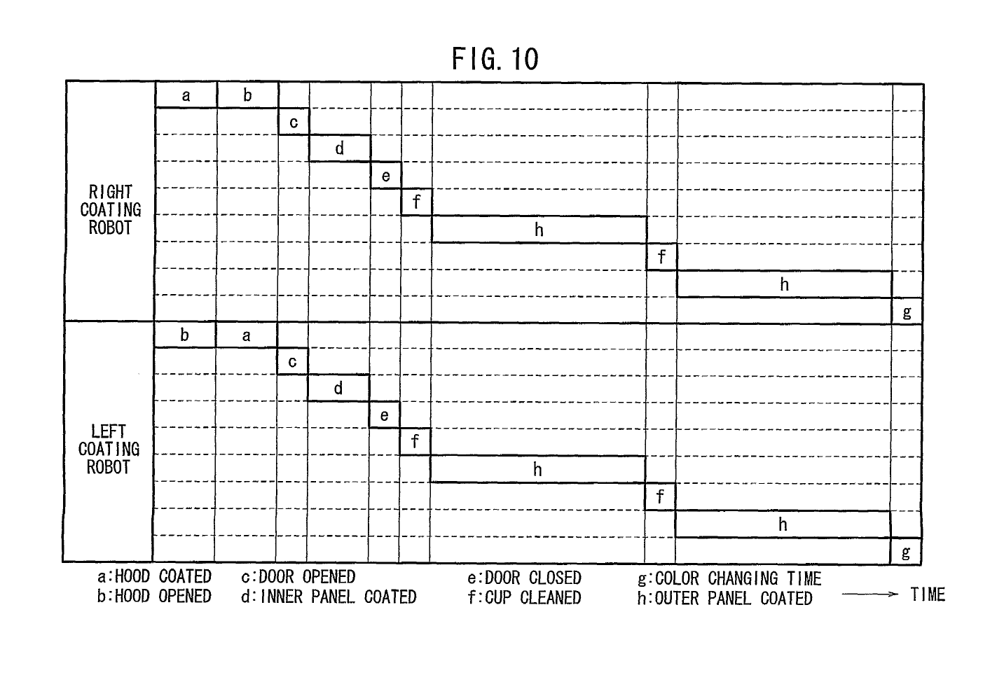

In the overcoat applying process 16 according to the first embodiment of the present invention, as shown in FIG. 10, when portions of the outer and inner panels of the vehicle body W are coated with an overcoat layer in the first overcoat applying station 34a, the engine hood is held open by the left coating robot 36a, and a portion of the engine hood is coated by the right coating robot 36a. Then, the engine hood is held open by the right coating robot 36a, and the remaining portion of the engine hood is coated by the left coating robot 36a.

When the doors of the vehicle body W are opened by the coating robots 36a, a portion of the inner panel is coated. Then, the doors are closed by the coating robots 36a, and cups of the coating robots 36a that have been used are cleaned. Thereafter, the outer panel of the vehicle body W is coated by the left and right coating robots 36a. Then, the cups of the coating robots 36a that have been used are cleaned, and the outer panel of the vehicle body W is coated by the remaining coating robots 36a.

In the conventional overcoat applying process 66, as described above, after the vehicle body W has been coated in the inner panel coating station 60, the first outer panel coating station 62, and the second outer panel coating station 64, the coating process is interrupted for a predetermined color changing time. The color changing time is longer than the time that is actually required to clean the cups. Therefore, the coating process is interrupted for an unnecessarily long period of time, and hence, the coating process is considerably time-consuming.

According to the first embodiment of the present invention, the first through third overcoat applying stations 34a through 34c are made available for applying coats of different colors. When the coating colors need to be changed, the vehicle body W may simply be transferred from the first overcoat applying station 34a to the second overcoat applying station 34b, for example. Thus, the coating system 10 according to the first embodiment is easily adaptable to production of vehicles in many types and small quantities, and can perform an efficient coating process.

Since the coating system 10 requires no unwanted color changing wait time, the coating process can be performed easily and quickly in a short period of time. Although the coating system 10 uses coating robots 36a as door opening and closing robots, the entire coating process is prevented from becoming delayed. The number of robots used by the coating system 10 may be reduced in order to make the entire coating facility compact.

The conventional overcoat applying process 66 also requires an air-conditioned booth that covers an area extending from the inner panel coating station 60 to the second outer panel coating station 64. The entire length of the air-conditioned booth is large, because it includes a feed path for the vehicle bodies W. According to the first embodiment, however, because an air-conditioned booth covering the first overcoat applying station 34a, for example, is limited to an area for covering the vehicle body W, the amount of air-conditioning energy supplied to the air-conditioned booth can be reduced.

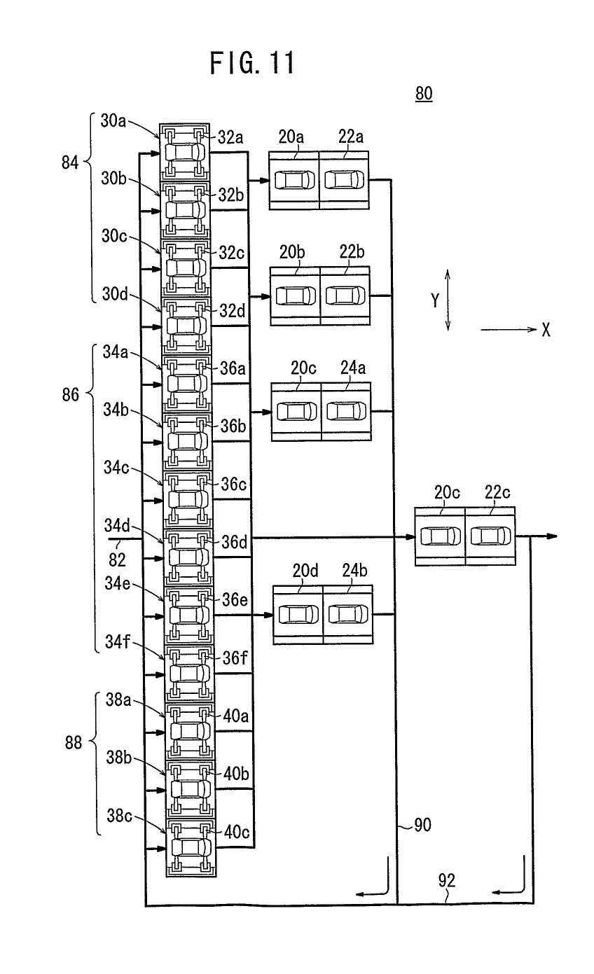

FIG. 11 shows a schematic plan view of a coating system 80 according to a second embodiment of the present invention. Those parts of the coating system 80 which are identical to those of the coating system 10 according to the first embodiment are denoted by identical reference characters, and such parts shall not be described in detail below.

As shown in FIG. 11, the coating system 80 has a coating line 82 extending in a coating flow direction, i.e., in the direction indicated by the arrow X. The coating line 82 includes an intermediate coat applying process 84, an overcoat applying process 86, and a clear coat applying process 88, which are disposed in parallel to each other across the coating line 82 in the direction indicated by the arrow Y, which is perpendicular to the direction indicated by the arrow X.

The intermediate coat applying process 84 has a first intermediate coat applying station 30a, a second intermediate coat applying station 30b, a third intermediate coat applying station 30c, and a fourth intermediate coat applying station 30d, which are disposed in parallel to each other across the coating line 82 in the direction indicated by the arrow Y. The first through fourth intermediate coat applying stations 30a through 30d include respective sets of coating robots 32a, 32b, 32c, 32d.

The overcoat applying process 86 includes a first overcoat applying station 34a, a second overcoat applying station 34b, a third overcoat applying station 34c, a fourth overcoat applying station 34d, a fifth overcoat applying station 34e, and a sixth overcoat applying station 34f, which are disposed in parallel to each other across the coating line 82 in the direction indicated by the arrow Y. The first through sixth overcoat applying stations 34a through 34f include respective sets of coating robots 36a, 36b, 36c, 36d, 36e, 36f.

The first through sixth overcoat applying stations 34a through 34f are operated to selectively apply coatings under at least two different coating conditions, e.g., coatings having different colors, to the vehicle bodies W that are fed along the coating line 82. The coating colors that can be applied to the vehicle bodies W can be selected as desired.

The clear coat applying process 88 includes a first clear coat applying station 38a, a second clear coat applying station 38b, and a third clear coat applying station 38c. The first through third clear coat applying stations 38a through 38c include respective sets of coating robots 40a, 40b, 40c.

The first through fourth intermediate coat applying stations 30a through 30d, the first through sixth overcoat applying stations 34a through 34f, and the first through third clear coat applying stations 38a through 38c are arranged in a linear array along the direction indicated by the arrow Y, and further provide respective booths that are air-conditioned either individually or as a group.

The coating system 80 also includes a first setting unit 20a and a first drying furnace (heating unit) 22a, a second setting unit 20b and a second drying furnace 22b, a third setting unit 20c and a first preheating unit (heating unit) 24a, and a fourth setting unit 20d and a second preheating unit (heating unit) 24b, which are disposed downstream of the intermediate coat applying process 84, the overcoat applying process 86, and the clear coat applying process 88 along the coating flow direction, and further, which are disposed in parallel to each other in the direction indicated by the arrow Y.

The coating line 82 includes a first return line 90 for returning the vehicle bodies W from positions immediately downstream of the first drying furnace 22a, the second drying furnace 22b, the first preheating unit 24a, and the second preheating unit 24b along the coating flow direction, to positions immediately upstream of the intermediate coat applying process 84, the overcoat applying process 86, and the clear coat applying process 88. The coating system 80 further includes a fifth setting unit 20e and a third drying furnace 22c disposed downstream of the first return line 90. A second return line 92 extends from a position immediately downstream of the third drying furnace 22c to the first return line 90.

According to the second embodiment, the intermediate coat applying process 84 having the first through fourth intermediate coat applying stations 30a through 30d, the overcoat applying process 86 having the first through sixth overcoat applying stations 34a through 34f, and the clear coat applying process 88 having the first through third clear coat applying stations 38a through 38c, are disposed in parallel to each other across the coating line 82.

The coating system 80 thus configured makes it possible to adjust the coating time depending on coating specifications when the number of coating cycles is changed. By reducing the tact time in this manner, reductions in throughput of the coating system 80 can easily be avoided. The coating system 80 also makes it possible to change setups quickly and easily in order to change coating conditions, e.g., coating colors.

According to the second embodiment, the number of stations that make up each of the intermediate coat applying process 84, the overcoat applying process 86, and the clear coat applying process 88 can easily be increased or reduced, depending on the coating pattern that is to be applied to the vehicle bodies W. For example, the first coat pattern shown in FIG. 4 has a double-layer base structure, including the first base coat layer 50a and the second base coat layer 50b. Consequently, for applying the first coating pattern shown in FIG. 4, it is desirable to increase the coating colors used in the overcoat applying process 86.

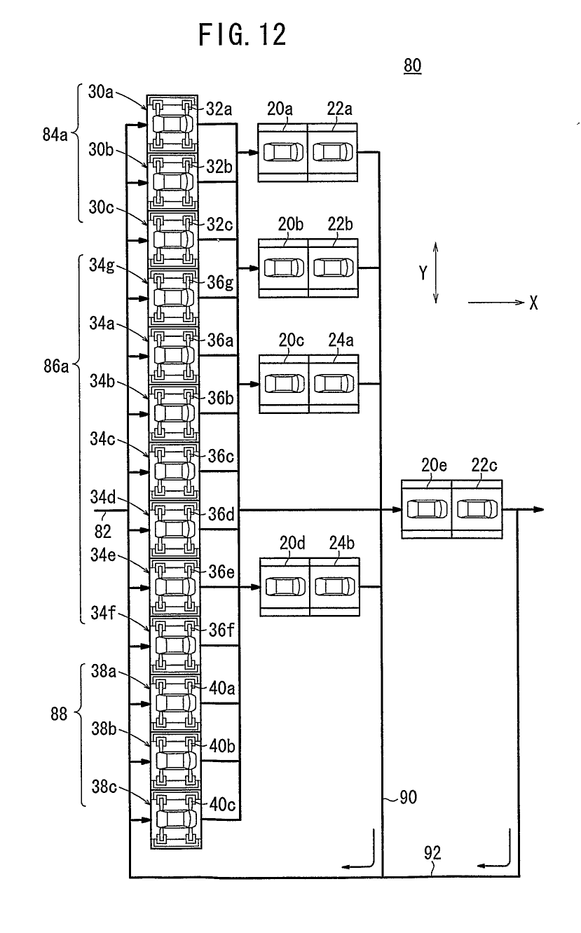

To meet such a demand, as shown in FIG. 12, the coating system 80 is reconfigured to include an intermediate coat applying process 84a having first through third intermediate coat applying stations 30a through 30c, an overcoat applying process 86a having first through seventh overcoat applying stations 34a through 34g, and a clear coat applying process 88a having first through third clear coat applying stations 38a through 38c, wherein the intermediate coat applying process 84a, the overcoat applying process 86a, and the clear coat applying process 88a are disposed in parallel to each other across the coating line 82.

Specifically, the fourth intermediate coat applying station 30d of the intermediate coat applying process 84a is replaced by the seventh overcoat applying station 34g of the overcoat applying process 86a. The seventh overcoat applying station 34g includes a plurality of coating robots 36g. It is thus quick and easy to change from a standard-type coating pattern to the first coating pattern.

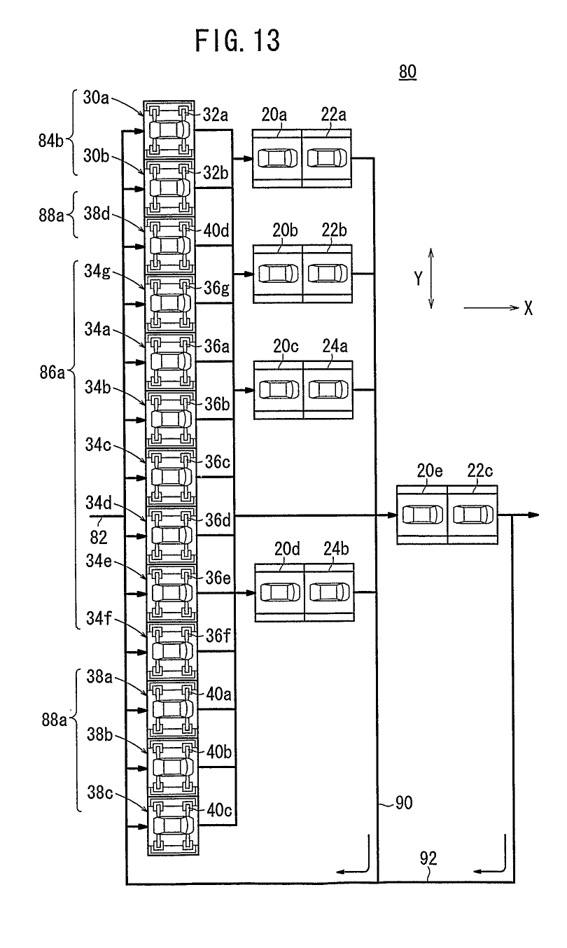

To apply the second coat pattern shown in FIG. 6, the coating system 80 is reconfigured as shown in FIG. 13. The second coat pattern has a double-base-layer structure, including the first base coat layer 50a and the second base coat layer 50b, and a double-clear-layer structure, including the first clear coat layer 52a and the second clear coat layer 52b.

As shown in FIG. 13, the coating system 80 is reconfigured to include an intermediate coat applying process 84b having first and second intermediate coat applying stations 30a, 30b, an overcoat applying process 86a having first through seventh overcoat applying stations 34a through 34g, and a clear coat applying process 88a having first through fourth clear coat applying stations 38a through 38d, wherein the intermediate coat applying process 84b, the overcoat applying process 86a, and the clear coat applying process 88a are disposed in parallel to each other across the coating line 82.

Specifically, the third intermediate coat applying station 30c of the intermediate coat applying process 84 is replaced by the fourth clear coat applying station 38d of the clear coat applying process 88a. The fourth clear coat applying station 38d also includes a plurality of coating robots 40d. The coating system 80 is thus versatile, in that it is capable of easily and quickly adapting itself to various different coating patterns, and is able to perform the coating process efficiently and reliably.

Depending on the types of coatings that are used in the coating system 80 shown in FIG. 11, the first and second drying furnaces 22a, 22b may be replaced with preheating units, or the first and second drying furnaces 22a, 22b and the first and second preheating units 24a, 24b may be dispensed with altogether. On the coating line 82, the fifth setting unit 20e and the third drying furnace 22c may also be used repeatedly by returning the vehicle bodies W along the second return line 92.

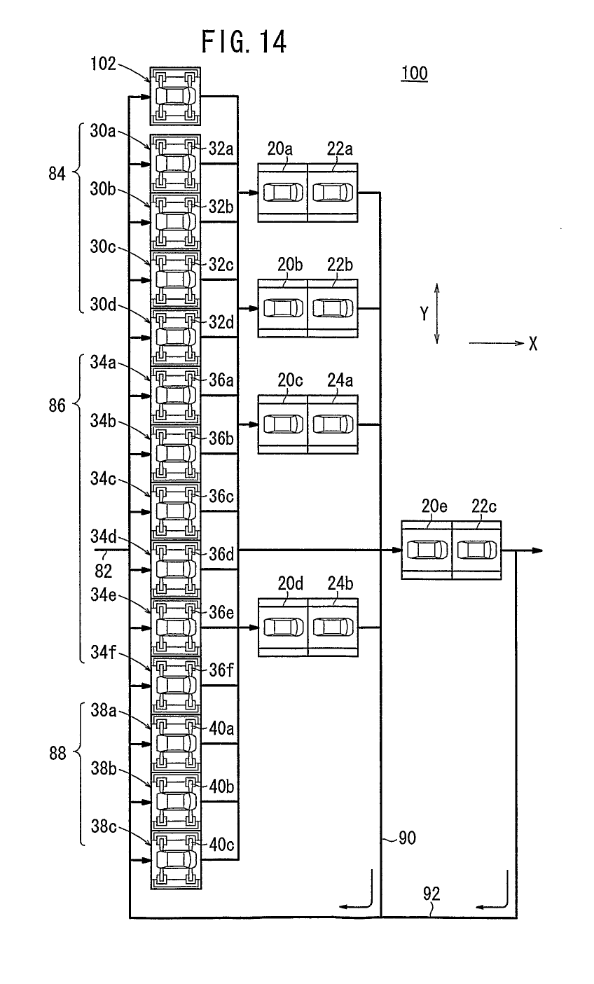

FIG. 14 shows a schematic plan view of a coating system 100 according to a third embodiment of the present invention. Those parts of the coating system 100 which are identical to those of the coating system 80 according to the second embodiment are denoted by identical reference characters, and such parts shall not be described in detail below.

As shown in FIG. 14, the coating system 100 additionally includes a wet sanding station 102, which is disposed alongside of the intermediate coat applying process 84. The wet sanding station 102 includes a function for polishing an applied intermediate coat with water to improve tone, depth, and smoothness of the intermediate coat.

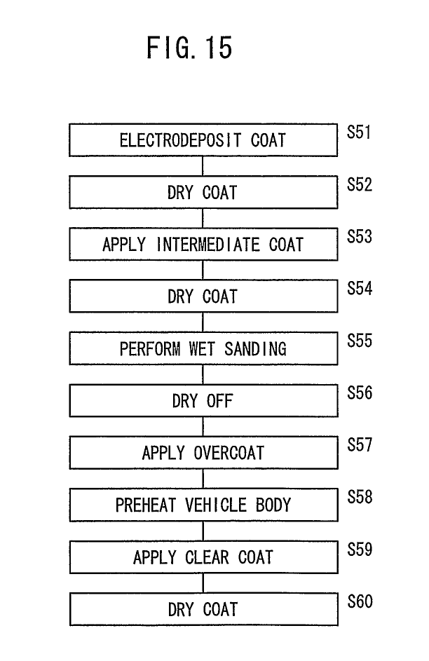

A coating process performed by the coating system 100 shall be described below with reference to the flowchart shown in FIG. 15.

Steps S51 through S54 of the process shown in FIG. 15 are carried out in the same manner as steps S1 through S4 shown in FIG. 3. From the first drying furnace 22a, the vehicle body W is returned along the first return line 90 to the wet sanding station 102. In the wet sanding station 102, the intermediate coat applied to the vehicle body W is polished with water in step S55. Thereafter, the vehicle body W is delivered to the third setting unit 20c, for example. After the vehicle body W has been processed in the third setting unit 20c, it is delivered from the third setting unit 20c to the first preheating unit 24a, where the vehicle body W is dried off in step S56.

Then, the vehicle body W is fed along the first return line 90 to the overcoat applying process 86. Thereafter, the coating process is performed on the vehicle body W in steps S57 through S60, which are identical to steps S5 through S8 shown in FIG. 3.

According to the third embodiment, since the vehicle body W that has been polished by the wet sanding station 102 is dried by the first preheating unit 24a, the coating system 100 does not require a dedicated drying furnace, since the first preheating unit 24a itself functions as a drying furnace. Therefore, the coating system 100 is highly economical.

Although certain preferred embodiments of the present invention have been shown and described in detail, it should be understood that various changes and modifications may be made therein without departing from the scope of the invention set forth in the appended claims.

1. A coating system comprising:
at least an intermediate coat applying process and an overcoat applying process for coating portions of an outer panel and an inner panel of a workpiece to be coated;
each of said intermediate coat applying process and said overcoat applying process comprising at least two coating stations for coating the workpiece under different conditions, wherein said coating stations are disposed in parallel to each other across a coating line.

2. A coating system according to claim 1, further comprising:
a clear coat applying process for coating said workpiece;
said clear coat applying process having at least two coating stations for coating the workpiece under different conditions, wherein said coating stations are disposed in parallel to each other across said coating line.

3. A coating system according to claim 2, wherein said intermediate coat applying process, said overcoat applying process, and said clear coat applying process are spaced at predetermined intervals along said coating line.

4. A coating system according to claim 3, further comprising:
a setting unit disposed between said intermediate coat applying process and said overcoat applying process; and
a heating unit disposed between said overcoat applying process and said clear coat applying process.

5. A coating system comprising:
at least an intermediate coat applying process and an overcoat applying process for coating portions of an outer panel and an inner panel of a workpiece to be coated;
said intermediate coat applying process and said overcoat applying process being disposed in parallel to each other across a coating line;
said intermediate coat applying process comprising at least two coating stations disposed in parallel to each other; and
said overcoat applying process comprising at least two coating stations disposed in parallel to each other.

6. A coating system according to claim 5, further comprising:
a clear coat applying process for coating the workpiece, wherein said clear coat applying process is disposed in parallel to said intermediate coat applying process and said overcoat applying process;
said clear coat applying process comprising at least two coating stations disposed in parallel to each other.

7. A coating system according to claim 6, wherein said intermediate coat applying process, said overcoat applying process, and said clear coat applying process are disposed in parallel to each other across said coating line.

8. A coating system according to claim 7, further comprising:
a return line for returning said workpiece from a position downstream of said intermediate coat applying process, said overcoat applying process, and said clear coat applying process along said coating line to a position upstream of said intermediate coat applying process, said overcoat applying process, and said clear coat applying process along said coating line.

9. A coating system according to claim 7, further comprising:
a plurality of setting units and heating units disposed in parallel to each other downstream of said intermediate coat applying process, said overcoat applying process, and said clear coat applying process along said coating line.

10. A method of coating portions of an outer panel and an inner panel of a workpiece, comprising the steps of:
providing at least an intermediate coat applying process and an overcoat applying process for coating said workpiece, wherein each of said intermediate coat applying process and said overcoat applying process comprises at least two coating stations for coating the workpiece under different conditions, wherein said coating stations are disposed in parallel to each other across a coating line;
selecting one of said coating stations which corresponds to given coating conditions; and
coating said workpiece in the selected coating station.

11. A method according to claim 10, further comprising the steps of:
providing a clear coat applying process for coating said workpiece, said clear coat applying process comprising at least two coating stations for coating the workpiece under different conditions, wherein said coating stations are disposed in parallel to each other across said coating line;
selecting one of said coating stations, which corresponds to given coating conditions; and
coating said workpiece in the selected coating station.

12. A method according to claim 11, further comprising the step of:
after said workpiece has been coated in the selected coating station, delivering said workpiece successively through a setting unit and a heating unit.

13. A method according to claim 12, further comprising the step of:
after said workpiece has been delivered through said setting unit and said heating unit, returning said workpiece to one of said coating stations, if necessary; and
coating said workpiece in said one coating station under different coating conditions.

14. A method of coating portions of an outer panel and an inner panel of a workpiece, comprising the steps of:
providing at least an intermediate coat applying process and an overcoat applying process for coating said workpiece, said intermediate coat applying process and said overcoat applying process being disposed in parallel to each other across a coating line, wherein said intermediate coat applying process comprises at least two coating stations, and said overcoat applying process comprises at least two coating stations;
selecting one of said coating stations of said intermediate coat applying process;
applying an intermediate coat to said workpiece in the selected coating station of said intermediate coat applying process;
returning said workpiece along a return line to said overcoat applying process;
selecting one of said coating stations of said overcoat applying process; and
applying an overcoat to said workpiece in the selected coating station of said overcoat applying process.

15. A method according to claim 14, further comprising the steps of:
providing a clear coat applying process for coating the workpiece, said clear coat applying process being disposed in parallel to said intermediate coat applying process and said overcoat applying process, said clear coat applying process comprising at least two coating stations;
selecting one of said coating stations of said clear coat applying process; and
applying a clear coat to said workpiece in the selected coating station of said clear coat applying process.

16. A method according to claim 15, further comprising the step of:
each time said workpiece is coated in said intermediate coat applying process, said overcoat applying process, and said clear coat applying process, delivering said workpiece through at least one of a setting unit and a heating unit.
